(19) United States
(12) Patent Application Publication
(10) Pub. No.: US 2019/0161330 A1
(43) Pub. Date: May 30, 2019

(54) INDUSTRIAL VEHICLE WITH A PENDULUM AXEL

(71) Applicant: ZF Friedrichshafen AG, Friedrichshafen (DE)

(72) Inventor: Christian STAMMBERGER, Vilshofen (DE)

(21) Appl. No.: 16/194,687

(22) Filed: Nov. 19, 2018

(30) Foreign Application Priority Data
Nov. 29, 2017 (DE) 10 2017 221 375.2

(51) Int. Cl. B66F 9/075; B60G 9/02; B66F 17/00

(52) U.S. Cl. CPC B66F 9/07559; B60G 9/02; B60G 2200/322; B60G 2300/022; B66F 17/003

(57) ABSTRACT

An industrial conveyor vehicle with four wheels (4, 5), a vehicle chassis (2) and a rear axle (1) in the form of a pendulum axle (1), which is mounted in a pivot mounting (3) supported on the vehicle chassis (2) and can undergo pivoting movements within the range of a pivot angle about a pivot axis (a) that extends in the longitudinal direction of the vehicle. Depending on the situation driving situation, a maximum pivot angle (α₁, α₂) can be set which limits the pivoting movements.

This application claims priority from German patent application serial no. 10 2017 221 375.2 filed Nov. 29, 2017.

### FIELD OF THE INVENTION

The invention relates to an industrial vehicle.

### BACKGROUND OF THE INVENTION

Industrial vehicles, in particular forklift trucks with four wheels in which the rear axle is in the form of a pendulum axle, are known, for example from the commercially available forklift truck by the company Toyota with a stability system known by the name SAS (System of Active Stability). The known pendulum axle, which is mounted on the chassis of the vehicle by means of a pivot joint, is used to compensate for unevenness of the ground. For this there is a so-termed stability triangle formed by the ground contact points of the front wheels and the point where the pendulum axle is supported. If the center of gravity of the forklift is within this stability triangle, then the vehicle is in a stable condition. But if the center of gravity is outside the triangle, the vehicle is in an unstable condition, i.e. the vehicle can topple over. To avoid that risk the pendulum axle in the Toyota SAS system is set by a locking cylinder with the result that the pendulum axle can no longer pivot, but becomes a solid axle. Thereby the aforementioned stability triangle is converted into a stability rectangle formed by the ground contact points of all four wheels, whereby the stability of the vehicle is increased. However, unevenness of the ground can then no longer be compensated for by the four wheels.

From DE 44 08 757 A1 an industrial vehicle, in particular a forklift truck with four wheels and a swing arm, also known as a pendulum axle is known, which is mounted to pivot about an axis relative to the chassis of the vehicle. Associated with the pendulum axle, at the opposite ends of which wheels are arranged, is a stabilizing device which if a predetermined lifting height of the load carrier is exceeded, moves the pendulum axle to its central position and locks it there unto the pendulum axle is released again when the lifting height becomes less than the predetermined height.

### SUMMARY OF THE INVENTION

The purpose of the present invention is to improve the stability of an industrial vehicle of the type described at the start, and at the same time to maintain ground contact of the wheels in all relevant driving situations.

The invention is based on the characteristics specified in the independent claims. Advantageous design features emerge from the subordinate claims.

According to the invention, it is provided that a maximum pivoting angle —which depends on the situation—can be set, whereby the pivoting movements of the pendulum axle are restricted. A pendulum axle is understood to be an axle body or swing arm which is articulated on the vehicle chassis by means of a pivot joint and which can pivot about an axis that extends in the longitudinal direction of the vehicle, i.e, it can carry out pivoting movements. The maximum pivoting angle that can be set is chosen as a function of the intended use of the industrial vehicle, for example if the ground surface is relatively flat, such as in an industrial building or shed, relatively small pivoting angles are chosen since these are enough to compensate for unevenness of the ground by a slight pivoting movement. The maximum pivoting angle can either be set by the driver of the vehicle, or set automatically. When the maximum pivoting angle is reached the pivoting movement is blocked, whereby the stability area is displaced and improved stability is achieved.

In a preferred embodiment, within the swiveling or pivoting range of the pendulum axle, limiting elements are provided on the vehicle chassis, whose effect is that when the maximum pivoting angle is reached, the pivoting movement is blocked. The pendulum axle is then supported with half of the axle body on the vehicle chassis, whereby the stability area is shifted from the center toward the outside.

According to a further preferred embodiment, associated with the limiting elements there are adjusting devices such that preferably the height of the limiting elements (namely in the z-direction of the vehicle) can be adjusted by motors.

In another preferred embodiment the adjusting devices are in the form of electric or hydraulic servomotors, which move the limiting elements, preferably in the form of stops or damping devices, to the desired stop positions.

According to a further preferred embodiment the maximum pivoting angle can be set as a function of current operating parameters, for example as a function of the speed of the vehicle, the steering angle of the steered wheels, the lifting height of the bad and the loading condition, and the currently set pivoting angle. In this way—according to the situation—an optimum maximum pivoting angle is set automatically.

In a further preferred embodiment the operating parameters can be measured by sensors and sent to a control unit, where they are processed and converted into control commands for the adjusting devices.

### BRIEF DESCRIPTION OF THE DRAWINGS

An example embodiment of the invention is illustrated in the drawings and will be described in greater detail below, so that further features and/or advantages can emerge from the description and/or the drawings. The drawings show:

FIG. 1: A schematic representation of a pendulum axle mounted on a vehicle chassis, and

FIG. 2: A view from above, of a four-wheel industrial vehicle with a pendulum axle and a stability triangle.

### DETAILED DESCRIPTION OF THE PREFERRED EMBODIMENTS

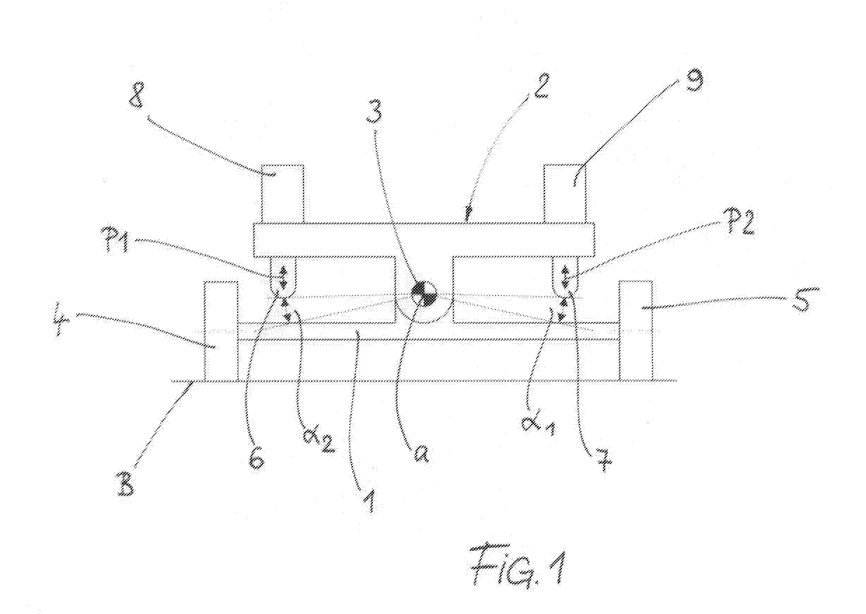

FIG. 1 shows a rear axle, in the form of a pendulum axle 1 of an industrial vehicle, with a vehicle chassis 2 on which the pendulum axle 1 is supported by means of a pivot joint 3 so that it can pivot. The pendulum axle 1 comprises an axle body 1 at the ends of which two wheels 4, 5 are mounted to rotate. The wheels 4, 5, also called rear wheels 4, 5, rest on a ground surface B which in this case is shown as being flat. The pivot joint 3 has a pivot axis a that extends in the longitudinal direction of the vehicle, also called the x-direction, and is perpendicular to the plane of the drawing. The pendulum axle 1 pivots about the pivot axis a within the range of the pivot angles α₁ (on the right) and α₂ (on the left). On the vehicle chassis 2 are arranged pivot angle limiters 6, 7 in the form of stops 6, 7, respectively shown by the double arrows P1, P2 in the z-direction. Associated with the pivot angle limiters 6, 7 there are adjusting devices 8, 9 which are in the form of servomotors, preferably hydraulic or electric servomotors, and which set the maximum possible pivot angles α₁ and α₂ by motorized adjustment of the stops 6, 7.

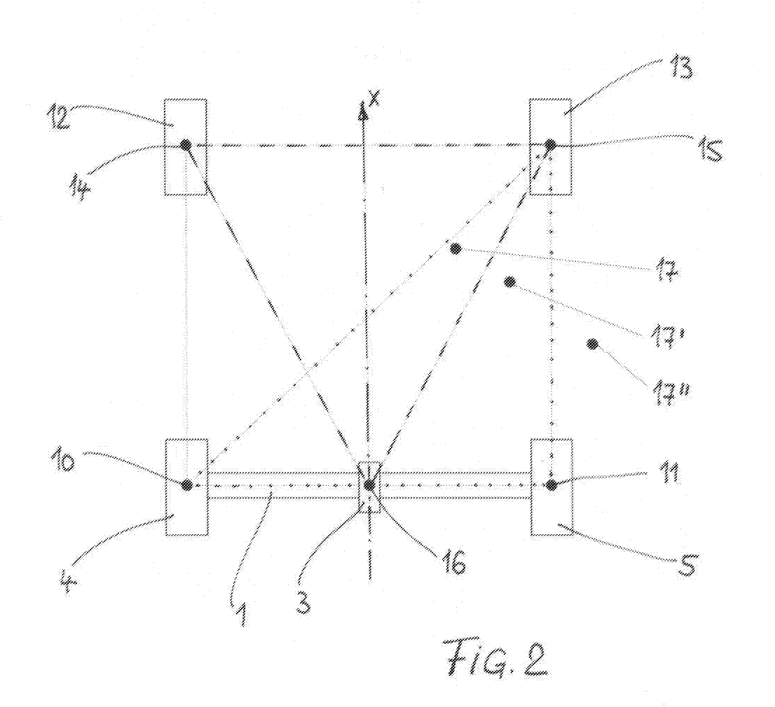

FIG. 2 shows a view from above, of the four-wheel industrial vehicle in FIG. 1. The rear axle in the form of a pendulum axle 1 is supported by the rear wheels 4, 5 on the ground and forms ground contact points 10, 11. The front wheels 12, 13, which cannot move in the vertical direction relative to the vehicle chassis 2 (FIG. 1), rest on the ground and form ground contact points 14, 15. The pendulum axle 1 pivots in the pivot joint 3 about the pivot axis a, which extends in the x-direction of the vehicle. The center of the pivot joint 3, which forms the point of support of the vehicle chassis 2 (FIG. 1) relative to the pendulum axle 1, is indexed 16. In normal driving operation the size of the actual pivot angles of the pendulum axle 1 is smaller than the maximum pivot angles α₁, α₂ (FIG. 1). In this condition the ground contact points 14, 15 of the front wheels 12, 13 and the midpoint 16 of the pivot joint 3 form a first stability triangle, shown in the figure by broken lines. It is assumed that a resultant force vector, which combines the weight and acceleration forces acting upon the vehicle, meets the first stability triangle 14, 15, 16 at a point of application 17. Since the point of application 17 lies within the first stability triangle 14, 15, 16, the vehicle stands or drives in a stable manner, i.e. there is no risk of its toppling over. But if the point of application 17 of the force vector moves outside the first stability triangle 14, 15, 16, for example to a further position denoted by a second point of application 17′, then there is a critical driving situation. Without limiting the pivot angle of the pendulum axle 1, under these conditions the vehicle would topple. Such toppling is prevented by the structure of the pendulum axle 1 according to the invention, with limitation of the pivot angle to the maximum pivot angle α₁, α₂ (FIG. 1). In such a case the pendulum axle 1 is deflected by the right-hand pivot angle limiter 7 (FIG. 1). The axle body 1 is on the one hand connected by means of the pivot joint 3 to the vehicle chassis 2 (FIG. 1) and on the other hand is supported on the right-hand pivot angle limiter 7 (FIG. 1). In this condition the pendulum axle 1 cannot be deflected any farther. In this situation the left-hand front wheel 12 is already raised off the ground. The consequence is that a second stability triangle is formed, which consists of the wheel ground contact point 15 of the right-hand front wheel 13 and the wheel ground contact points 10, 11 of the rear wheels 4, 5, indicated in the figure by dotted lines. So long as the point of application 17′ remains within the second stability triangle 15, 11, 10, a stable standing or stable driving situation exists. It is true that the left-hand front wheel 12 can be raised off the ground, but the vehicle will still not topple. Only if the resultant force vector moves outside the second stability triangle 15, 11, 10 to a third position 17″ will the vehicle topple.

The smaller the maximum pivot angles α₁, α₂ are set, the more certain it is that the resultant force vector will be within one of the two stability triangles 14, 15, 16 or 15, 11, 10 so that the stability of the vehicle is ensured. The pivot angle limiters 6, 7 can preferably be set with the help of the adjusting devices 8, 9 in two ways: the setting can be done independently of the current driving situation, for example by the driver of the vehicle, In doing this, the flatness of the ground can be taken into account in order to, on the one hand, have a sufficiently large maximum pivot angle available, and on the other hand to ensure as great a standing stability as possible. On the other hand, the current driving situation can be detected by sensors (not shown), for example by measuring the driving speed of the vehicle, the steering angle, the lifting height, the loading condition and/or the current pivot angle of the pendulum axle 1. The measured values are sent as signals to a control unit (not shown), which sets the pivot angle limiters or stops 6, 7 optimally during driving. The maximum pivot angles α₁, α₂ can be set between zero and a maximum value that depends on the design of the axle. The adjusting devices are preferably in the form of electric servomotors or hydraulic cylinders.

1 Pendulum axle/axle body

2 Vehicle chassis

3 Pivot joint

4 Rear wheel

5 Rear wheel

6 Pivot angle limiter

7 Pivot angle limiter

8 Adjusting device

9 Adjusting device

10 Ground contact point

11 Ground contact point

12 Front wheel

13 Front wheel

14 Ground contact point

15 Ground contact point

16 Mid-point of pivot joint

17 Point of application

17′ Point of application

17″ Point of application

a Pivot axis

x Longitudinal direction of the vehicle

α₁ Right-hand pivot angle

α₂ Left-hand pivot angle

B Ground

P1 Adjusting device

P2 Adjusting device

1-7. (canceled)

8. An industrial vehicle comprising:
four wheels (4, 5, 12, 13),
a vehicle chassis (2), and
a rear axle (1) in a form of a pendulum axle (1),
the pendulum axle being mounted in a pivot mounting (3) on the vehicle chassis (2) for undergoing pivoting movement about a pivot axis (a) that extends in a longitudinal direction (x) of the vehicle, and, depending upon a driving situation, a maximum pivot angle (α₁, α₂) that limits the pivoting movements being settable.

9. The industrial vehicle according to claim 8, wherein limiting elements (6, 7) are arranged on the vehicle chassis (2) within a swiveling or a pivoting range of the pendulum axle (1).

10. The industrial vehicle according to claim 9, wherein adjusting devices (8, 9) are associated with the limiting elements (6, 7).

11. The industrial vehicle according to claim 9, wherein the limiting elements are in a form of stops (6, 7).

12. The industrial vehicle according to claim 10, wherein the adjusting devices (8, 9) are in a form of either electric servomotors or hydraulic servomotors.

13. The industrial vehicle according to claim 8, wherein the maximum pivot angles (α₁, α₂) is set as a function of current operating parameters including one of a speed of the vehicle, a steering angle, a lifting height, a loading condition and a current pivot angle.

14. The industrial vehicle according to claim 13, wherein the current operating parameters are measurable by sensors and sent to a control unit.

15. An industrial vehicle comprising:
four wheels,
a vehicle chassis, and
a rear pendulum axle,
first and second wheels of the four wheels being rotatably mounted at opposite ends of the rear pendulum axle,
the rear pendulum axle being mounted on the vehicle chassis by a pivot joint that is located between the first and the second wheels, the rear pendulum axle being pivotable about a pivot axis that extends through the pivot join in a longitudinal direction of the vehicle such that the rear pendulum axle is pivotable relative to the vehicle chassis between first and second maximum pivot angles, and the first and the second maximum pivot angles, which limit pivotal movement of the rear pendulum axle, being set based on current operating conditions of the vehicle.

16. The industrial vehicle according to claim 15, further comprising first and second adjusting devices that are fixed on laterally opposite sides of the vehicle chassis, the first and the second adjustment devices communicate with first and second pivot angle limiters, respectively, and, based on the current operating conditions of the vehicle, the first and the second adjustment devices adjust an orientation of the first and the second pivot angle limiters relative to the rear pendulum axle to set the first and the second maximum pivot angles and limit the pivotal movement of the rear pendulum axle.

17. The industrial vehicle according to claim 16, wherein the first and the second maximum pivot angles are set based on at least one of a speed of the vehicle, a steering angle, a lifting height, a loading condition and a current pivot angle.
